(19) United States
(12) Patent Application Publication
(10) Pub. No.: US 2024/0341925 A1
(43) Pub. Date: Oct. 17, 2024

(54) CONNECTION DEVICE AND CONNECTION SYSTEM FOR DENTAL RECONSTRUCTION ON AN IMPLANT, DENTAL RECONSTRUCTION ON AN IMPLANT, AND METHOD FOR PERFORMING DENTAL RECONSTRUCTION ON AN IMPLANT

(71) Applicant: AJUST SÁRL, NEUCHATEL (CH)

(72) Inventor: Rémy TANIMURA, NEUILLY-SUR-SEINE (FR)

(73) Assignee: AJUST SÁRL, NEUCHATEL (CH)

(21) Appl. No.: 18/291,996

(22) PCT Filed: Jul. 25, 2022
(86) PCT No.: PCT/EP2022/070751

§ 371 Date: Jan. 25, 2024

Related U.S. Application Data
(60) Provisional application No. 63/246,108, filed on Sep. 20, 2021.

(30) Foreign Application Priority Data
Aug. 8, 2021 (FR) FR2108573

(51) Int. Cl. A61C 8/00

(52) U.S. Cl. CPC A61C 8/0068; A61C 8/0013; A61C 8/0016; A61C 8/0059

(57) ABSTRACT

A dental reconstruction includes a connection device with a first end bearing on an anchor and a second end supporting a prosthesis. The cross section decreases between the first end and the second end. The connection device defines a through-hole and an abutment. A fastening screw screws into an internally threaded portion of the anchor in order to fasten the connection device. A blocker has a cross section that increases upon insertion of the fastening screw into the through-hole. The blocker fits into a groove of the prosthesis covering the connection device. The screw head has a circular section bearing on the blocker in order to deform the blocker and fit the blocker into the groove of the prosthesis.

### BACKGROUND OF THE INVENTION

The invention relates to a coupling device, a coupling system for a dental restoration on an implant, a dental restoration on an implant, a method for performing a dental restoration on an implant.

### STATE OF THE ART

To perform a dental restoration on an implant, it is common practice to fix an implant in the jaw bone and to then fix a dental prosthesis directly on the implant or by means of an abutment. An abutment is an intermediate element that is fixed on the implant and that serves the purpose of attaching a dental prosthesis. The abutment is located between the implant and the dental prosthesis. The abutment provides the mechanical connection between the dental prosthesis and the implant, in general in conjunction with an abutment screw. The implant has a threaded inner section on which the prosthesis is fixed. A screw passes through the prosthesis and the abutment to press on the implant that acts as anchorage for the dental restoration. In conventional manner, the implant has a tapped section that enables the dental prosthesis to be fixed directly or indirectly. Different examples of achieving implants are illustrated in the documents JP5519985, JP2018-538014, EP1943978, EP2053985, EP3421004, EP3777760, WO2004/032786, WO2013/125924, WO2017/121898, U.S. Pat. Nos. 5,482,463, 8,033,826, 8,317,515, US2011/0213425, US2012/301850 and US2015/182309. The document EP2480161 illustrates an abutment comprising several parts. The documents EP2127612 and U.S. Pat. No. 6,663,388 also illustrate an abutment comprising two parts with the head defining a fixing axis for a prosthesis. The fixing axis of the prosthesis is not colinear with the axis of the implant. The documents U.S. Pat. Nos. 6,932,606 and 7,300,283 illustrate an anti-rotation device formed by deformable arms inserted in cavities of the abutment.

A large number of implant restorations require the use of a adhesive or cement for fixing the dental prosthesis to the abutment. However, it is particularly advantageous not to use adhesive or cement. Adhesion is in fact not a reproducible method, in particular as regards the thickness used and the quality of the adhesive. Elimination of the excess in the mouth is often difficult. Furthermore, adhesion is not reversible which results in a long and tedious operation when it is necessary to work on a restoration that has been stuck. The adhesive can be applied on the prosthesis (between the prosthesis and the abutment) outside the mouth before the assembly is re-inserted on the implant. This is then referred to as a trans-screwed prosthesis. This construction is not sterile and cannot be placed in an autoclave (134° C.).

When the axis of insertion of the prosthesis does not correspond to that of the axis of the implant, it is possible to use the abutments described above. However, as adjustment of the contact points of the dental prosthesis always has to be performed, this operation can become very difficult with an abutment that has been previously stuck with the prosthesis that will be transfixed into the implant. For example, an upgrade performed on a ceramic prosthesis may require a new heating operation and the adhesive has to be eliminated beforehand by high temperature heating. Oxidation and contamination phenomena may then be observed on the abutments.

For prostheses manufactured completely from machined ceramic and that are screwed directly onto the implants, without adhesion, sealing problems have been observed between the different components of the implant restoration. An inadequate concentration of the forces also exists during chewing phases on this assembly. This poor distribution of forces combined with the problem of tolerance and/or with the lack of perfect matching of the parts may lead to breaking of the dental prosthesis or of the components.

There is therefore an advantage to be had from using a dental prosthesis transfixed by means of a screw without adhesive with a coupling device, providing a better mastery of the dimensions of the different components of the implant restoration.

Different configurations of coupling devices on an abutment are illustrated in the document US2020/0138552. This document illustrates a coupling device screwed onto the abutment for a sealed restoration with a cement. It further describes a dental prosthesis trans-screwed directly onto the abutment without a coupling device. With use, such an embodiment proves difficult to use. The document U.S. Pat. No. 10,010,384 illustrates an abutment with a deformable head and a dental prosthesis. The fixing screw is fitted on the abutment before the assembly is inserted in the prosthesis. The transfixing screw of the abutment is inserted beforehand into the latter to reduce its size and to allow insertion of a screwdriver in the through hole of the dental prosthesis which is therefore of reduced size. The dental prosthesis has a groove in the underside surface enabling expansion of the head of the abutment by means of the abutment screw head to perform fixing of these two elements. This screw secures the prosthesis with the implant and prevents reverse deformation of the abutment head so that the prosthesis is secured firmly on the abutment. The abutment directly assumes blocking of the prosthesis. This configuration complicates adjustment of the contact points of the prosthesis as the connection axis of the abutment which is identical to that of the implant has to be compatible with the axis of insertion of the prosthesis. These axes are often not colinear. Furthermore, the abutment has to be fitted in place and removed several times which results in destruction of the peri-implant tissue attachment and contamination of the latter.

The document KR 10-1943437 presents a substantially identical teaching with an implant restoration with an abutment fixed in an implant having a tapped section. The dental prosthesis in the form of a single tooth is perforated by means of a through hole designed for a fixing screw to pass through. The dental prosthesis is placed on an abutment which also has a through hole. The fixing screw passes through the dental prosthesis and the abutment. The fixing screw operates in conjunction with the tapped section of the implant to perform fixing of the dental prosthesis with the implant.

The abutment and the implant have anti-rotation means preventing rotation of the abutment with respect to the implant around a rotation axis materialised by the fixing screw. The abutment has movable arms in its coronal part. The fixing screw has an increasing cross-section from its foot to its head so that installation of the fixing screw results in the movable arms being spread outwards. The movable arms are inserted in cavities of the dental prosthesis to form an anti-rotation means between the dental prosthesis and the fixing device. The shape of the head of the fixing screw and the shape of the through hole in the dental prosthesis complement one another to ensure a strong mechanical fixing. The dental prosthesis presses on the abutment which is itself pressing on the implant.

A substantially equivalent teaching is present in the document US 2020/0015940 that presents an implant fixed in the jaw bone, an abutment fitted pressing on the implant and a dental prosthesis fitted pressing on the abutment. The dental prosthesis and the abutment each have a through hole. The two through holes extend the tapped portion of the implant. The abutment is fitted on the implant and the dental prosthesis is then fitted on the abutment before the fixing screw is inserted. The fixing screw has an increasing cross-section from its foot to its head. The head of the abutment is provided with several deformable arms that are inserted into cavities of the dental prosthesis when fixing of the screw on the implant is performed. Fixing of the screw in the implant prevents deformation of the deformable arms and separation between the dental prosthesis and the abutment. In this configuration, there is no coupling device and the fixing screw alone performs blocking of the abutment and of the fins to secure the dental prosthesis. This configuration, like the previous example, requires an implant axis colinear with the insertion axis of the prosthesis. In practice, this situation is seldom encountered. The axis of the implant is different from that of insertion of the prosthesis. The fixing screw has a threaded lower end which attaches to a threaded area of the anchoring abutment. The fixing screw also has a flared head which acts on the fixing fins of an upper part of an intermediate element and another flared area which comes to bear on a stop of a lower part of the intermediate element. By screwing the fixing screw into the anchoring abutment, the fixing screw presses the lower part of the intermediate element against the anchoring abutment and deforms the fins to securely mount the prosthesis on the upper part of the intermediate element. As the screw has a flared head and an also flared intermediate portion resting on the intermediate element, the depth of penetration of the screw into the anchoring stud defines the pressure exerted between the lower part of the intermediate element and the anchoring stud, as well as the pressure exerted between the upper part of the intermediate element and the prosthesis. This configuration is difficult to adjust, depending on manufacturing deviations in the fixing screw, the prosthesis, the anchoring abutment, the lower part of the intermediate element and the upper part of the intermediate element. These adjustment difficulties lead to multiple disassembly and reassembly of the prosthesis, the fixing screw and the intermediate piece. In addition, this configuration does not appear to be able to effectively prevent the prosthesis from locking in rotation relative to the anchoring abutment.

The document WO2018/138630 divulges a dental restoration with an implant made from ceramic receiving a deformable coupling element and a dental prosthesis pressing on the implant. The implant does not have a tapped section designed to receive a fixing screw directly but by means of a head with an anti-rotational system and a radial groove receiving the deformable bottom portion of the coupling element. The bottom part and the top part of the coupling element are both provided with deformable arms. The coupling element is clipped into the implant before the fixing screw is inserted. The dental prosthesis is clipped to the top part of the coupling device. Once the fixing screw has been tightened in the tapped section, the deformable arms of the coupling device can no longer deform and the dental prosthesis is fitted fixedly on the implant. This coupling element with its internally threaded insert concerns assembly of a ceramic dental prosthesis directly on a ceramic implant without a tapped section. From a practical point of view, the difficulties of insertion of the prosthesis, of adjusting the contact points and those relating to the component matching tolerances are again present here.

### SUMMARY OF THE INVENTION

One object of the invention consists in remedying these shortcomings and more particularly in providing a coupling device that presents better performances than prior art devices to couple the dental prosthesis with an anchorage.

These shortcomings tend to be overcome by means of a coupling device for a dental restoration on an implant comprising:
a body extending in a longitudinal direction with a foot end and a head end, the body defining a through hole designed to receive a fixing screw and defining a stop for a screw head of said fixing screw, the through hole broadening out from the stop in the direction of the foot area to form a cavity designed to cover a head of a maxillary implant anchorage provided with a tapped portion, the body having a decreasing outer cross-section from the foot end to the head end;
a body having an outer wall which forms an external anti-rotation device extending opposite the cavity in a direction perpendicular to the longitudinal axis, the prosthesis being designed to face the head perpendicularly to the longitudinal axis.

The inner wall of the body defining the cavity forms an internal anti-rotation device configured to block rotation of the coupling device relative to the head, the internal anti-rotation device extending from the foot region, the internal anti-rotation device facing the external anti-rotation device perpendicularly to the longitudinal axis.

A blocker is fixed to the body and fitted movable between a retracted position and an extended position, the extended position having a larger outer cross-section than the cross-section of the retracted position, the blocker partially obstructing the through hole of the coupling device to deform on contact with the fixing screw, the blocker being designed to be inserted in a groove or a recess of a prosthesis covering the coupling device to immobilise the prosthesis on the coupling device in the longitudinal direction.

According to one feature of the invention, the blocker is arranged in the top half of the coupling device and is located between the stop and an apical end of the body. Preferably, the stop separates the blocker and the first part of the external anti-rotation device and/or separates the blocker and the cavity.

In preferential manner, the blocker is made from shape memory alloy.

In a particular embodiment, the outer wall of the body is covered by a covering layer made from compressible polymer material.

Advantageously, the outer wall of the body has at least one frusto-conical portion.

It is a further object of the invention to provide a coupling system that is more efficient than coupling systems of the prior art and in particular to couple a prosthesis with an anchorage.

This result tends to be achieved by means of a coupling system for a dental restoration prosthesis that comprises a coupling device according to any one of the configurations and comprising a fixing screw having a head with a circular cross-section to have a constant deformation of the blocker independently from the depth of insertion of the screw head in the through hole, the circular cross-section deforming the blocker when the screw head is pressing on the stop.

Advantageously, the screw head is totally embedded in the through hole when the screw head is pressing on the stop.

In a particular embodiment, the fixing screw has a length that is smaller than the length of the coupling device, the length being measured along the longitudinal axis.

Preferentially, the anchorage has a head designed to be salient from a gingiva, the head extending in a longitudinal direction and defining a tapped portion extending at least partially outside the gingiva and the jaw bone, the head having an outer cross-section that is complementary to the inner cross-section of the cavity, the head and cavity forming a rotation blocker configured to prevent rotation of the coupling device with respect to the head around an axis parallel to the longitudinal axis, the fixing screw being screwed into the tapped portion, the coupling device being fitted removable with respect to the head.

In advantageous manner, the tapped portion does not extend beyond the height of the overlap by the coupling device on the anchorage.

In a particular embodiment, the coupling device and anchorage define a clipping device configured to fix the coupling device to the anchorage by elastic deformation.

It is a further object of the invention to provide a dental restoration that is simpler to implement than the configurations of the prior art.

This result tends to be achieved by means of a dental restoration that comprises a coupling system according to any one of the foregoing configurations and that comprises a prosthesis having a through hole opening onto the through hole of the coupling device, the through hole of the prosthesis broadening out from its coronal end to its apical end.

In advantageous manner, the fixing screw is devoid of contact with the prosthesis.

Preferentially, the prosthesis is devoid of contact with the anchorage.

It is a further object of the invention to provide a method for performing a dental restoration that is simpler to implement than the configurations of the prior art.

This result tends to be achieved by means of a method for performing a dental restoration comprising the following steps:
providing an anchorage designed to be fixed on a jaw bone of a laboratory model, the anchorage having a head designed to be mounted salient with respect to the gingiva, the head defining a tapped portion extending at least partially outside the gingiva and the jaw bone;
providing a coupling device according to any one of the foregoing configurations;
providing a prosthesis defining a through hole;
inserting the coupling device in the prosthesis and then placing the assembly on the head, the coupling device being located between the head and the prosthesis;
passing a fixing screw through the through hole of the prosthesis and the through hole of the coupling device;
screwing the fixing screw into the tapped area until the fixing screw presses up against the stop, the fixing screw fixing the coupling device on the abutment or the implant and deforming the blocker so that the blocker is inserted in a groove or a recess of the prosthesis to fixedly assemble the coupling device and the prosthesis in the longitudinal direction,
removing the fixing screw and detach the assembly formed by the coupling device and the prosthesis from the anchorage of a laboratory model.
adjusting the assembly formed by the coupling device and the prosthesis in the mouth, then secure the assembly to the anchorage with the fixing screw.

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a side view of an implant restoration according to a first embodiment;

FIG. 2 schematically illustrates an opposite side view of an implant restoration according to a second embodiment;

FIG. 3 schematically illustrates an exploded view of an implant restoration not comprising a dental prosthesis;

FIG. 4 schematically illustrates a cross-sectional view of an implant restoration according to a third embodiment;

FIG. 5 schematically illustrates a cross-sectional view of an implant restoration according to a fourth embodiment, directly on an anchorage;

FIG. 6 schematically illustrates a cross-sectional view of the apical part of an implant restoration according to a fifth embodiment;

FIG. 7 schematically illustrates a side view of an blocker;

FIG. 8 schematically illustrates a cross-sectional view of the top part of an implant restoration according to a sixth embodiment;

FIG. 9 schematically illustrates a cross-sectional view of an implant restoration according to a seventh embodiment;

FIG. 10 schematically illustrates a top view of another embodiment of a blocker fitted on a coupling device;

FIG. 11 schematically illustrates a cross-sectional view of the apical part of an implant restoration according to an eighth embodiment;

FIG. 12 schematically illustrates a cross-sectional view of the peripheral part of an implant restoration;

FIG. 13 schematically illustrates an exploded view of another embodiment of an implant restoration without dental prosthesis;

FIG. 14a schematically illustrates a cross-sectional view of an implant restoration according to a fifth embodiment, directly on an anchorage;

FIG. 14b schematically illustrates an enlarged cross-sectional view of the connection between the implant abutment and the coupling device;

FIG. 15 schematically illustrates a side view of an implant restoration according to a sixth embodiment;

FIGS. 16a, 16b and 16c illustrate schematically and respectively a side view of a coupling device, an implant restoration according to a sixth embodiment and a top view of the blocker;

FIG. 17 schematically illustrates a cross-sectional view of an implant restoration according to a seventh embodiment;

FIG. 18 schematically illustrates a cross-sectional view of an implant restoration according to an eighth embodiment;

FIGS. 19a, 19b and 19c schematically illustrate a side view and an implant restoration according to a seventh embodiment, top views of the blocker and side views of the blocker in the extended position and in the retracted position;

FIG. 20 schematically illustrates a cross-sectional view of an implant restoration according to a ninth embodiment;

FIG. 21 schematically illustrates a cross-sectional view of an implant restoration according to a tenth embodiment;

FIG. 22 schematically illustrates a cross-sectional view of a separation step between the prosthesis and the coupling device.

### DETAILED DESCRIPTION

The dental restoration has an anchorage 1 that is provided with at least one implant 1a and preferentially with an implant 1a and an abutment 1b. The dental restoration is also provided with a coupling device 2 with a body, a dental prosthesis 3 and a fixing screw 4 also called prosthesis screw. The dental restoration is an implant dental restoration, i.e. a dental restoration that is anchored by means of an anchorage 1 having at least one implant 1a. The dental restoration is advantageously an implant restoration for a single tooth, i.e. a crown, or for several teeth, i.e. a bridge. The dental restoration can also be a healing collar, a coping, an imprint transfer device.

The anchorage 1 is anchored firmly in the jaw bone and extends beyond the bone. The anchorage 1 is terminated by a head 5 that is salient from the bone and the gingiva. The head 5 is convex and salient from the gingiva.

The implant 1a is a dental implant designed to be inserted in the jaw bone. The implant 1a is arranged flush with the bone. Once it has been installed, the implant 1a is unremovable from the jaw bone (lower or upper). The implant 1a acts as the anchorage 1 for the dental restoration. The implant 1a is preferably made from titanium, titanium alloy or ceramic, advantageously zirconia. The implant 1a preferably has an outer threaded portion 1a present on the outer wall to be anchored in a bone. The implant 1a with its convex and salient head 5 can be achieved according to the configurations known to persons skilled in the art. It is advantageous to manufacture the head 5 from metal or ceramic material (preferentially from zirconia).

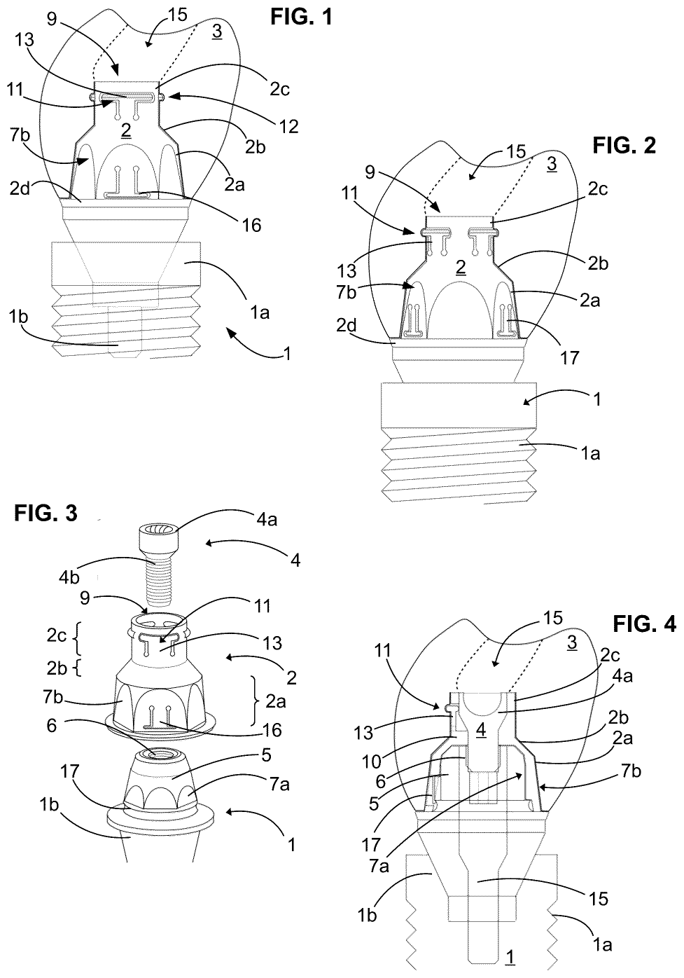

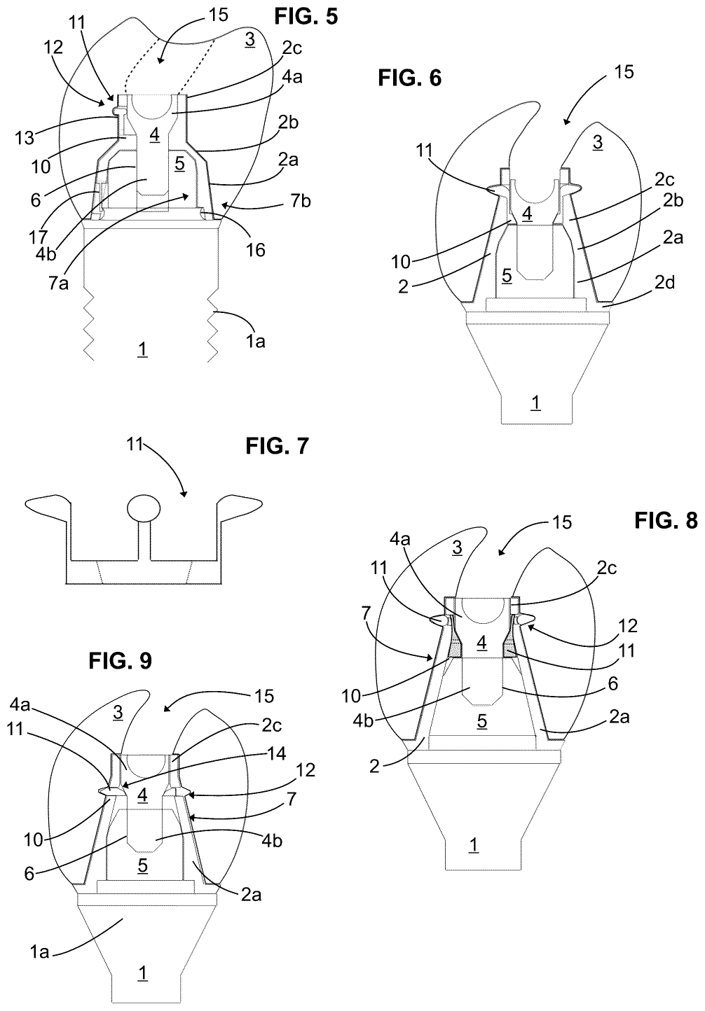

In one embodiment, the anchorage 1 has an implant 1a and an abutment 1b that is removable with respect to the implant 1a. The abutment 1b has an outer thread that is inserted in an inner thread of the implant 1a. The implant 1a is not salient from the gingiva and only the head 5 which terminates the abutment 1b is salient from the gingiva. In another configuration, the anchorage 1 is in a single piece. The implant 1a also forms the abutment 1b which is then unremovable. FIG. 5 illustrates an anchorage 1 in a single piece whereas FIGS. 1, 2 and 4 illustrate an implant 1a with a removable abutment 1b. FIG. 1 illustrates a particular embodiment of fixing of the abutment 1b in the implant 1a.

As illustrated in FIG. 3, the anchorage 1 defines a tapped portion 6 which opens out from the head 5. The tapped portion 6 is a portion with an inner thread that is designed to receive the fixing screw 4 to fix the coupling device 2 on the anchorage 1. The fixing screw 4 has a head 4a and a threaded portion 4b that operates in conjunction with the tapped portion 6 to secure the dental prosthesis 3 with the anchorage 1.

The use of an anchorage 1 provided with a salient convex head 5 enables the support of the prosthesis 3 to be offset with respect to the bone thereby reducing the risks of infection. The head 5 is a convex element of small height and small cross-section to be installed on the anchorage 1a when the latter is placed or when the anchorage 1a is exposed if it has been buried during osseointegration.

However, such a configuration of head 5 makes direct installation of the prosthesis 3 difficult. The dimensional differences existing between outer wall of head 5 and the cavity of the prosthesis 3 do in fact result in generation of large stresses. In the absence of fixing by adhesion, in particular by means of an abutment designed this purpose, it is commonplace for the ceramic prosthesis to end up by breaking. In the case of a metal prosthesis, premature wear of the interface is induced.

It is therefore particularly advantageous to use a coupling device 2 that performs the mechanical connection between the prosthesis 3 and the anchorage 1 and more particularly between the prosthesis 3 and head 5. The coupling device 2 is fitted on head 5. The coupling device 2 is fitted removable with respect to the anchorage 1 thereby facilitating adjustment of the prosthesis 3 with respect to the other teeth and with respect to the anchorage 1.

Once the anchorage 1 has been installed in the jaw bone, the coupling device 2 can be fitted and removed without having to perform any action on the anchorage 1 thereby avoiding excessive stressing of the anchorage 1 and contamination of the latter by adhesive.

The coupling device 2 can be made from metal or from polymer material or partly from metal and partly from polymer. The metal material used can be titanium or a titanium alloy. To form coupling element 2, it is particularly advantageous to use a shape memory alloy, for example an alloy mainly comprising Nickel and Titanium. It is preferable to use a shape memory alloy having a phase change temperature higher than or equal to 100° C. The polymer material used is preferentially chosen from PolyEtherEtherKetone (PEEK).

PolyEtherKetoneKetone (PEKK) or derivatives thereof. Other materials presenting the necessary mechanical performances and a biocompatibility are possible. In general manner, the material or materials chosen to form the coupling device 2 mean that the coupling device is hardly deformable when subjected to a compression effort in the longitudinal direction of the fixing screw. It is particularly advantageous to manufacture the coupling device 2 from metal and/or polymer material as this enables the dimensions of the coupling device 2 to be better mastered resulting in a better mastery of fixing on the anchorage 1 on a head 5 the dimensions of which are also well mastered. The coupling device 2 is not a tailor-made part that has to match the configuration of the jaw which means that the coupling device can be manufactured with the same dimensional control as head 5. This ensures a better mechanical connection between head 5 and the coupling device 2 in comparison with the mechanical connection between head 5 and the prosthesis 3.

The top surface of head 5 presses against an inner wall of the cavity of the coupling device 2. It is advantageous for the outer surface of head 5 to be complementary or as complementary as possible with the inner surface of the cavity defined in the coupling device 2 to ensure that the chewing forces are properly absorbed. The coupling device 2 enables the contact surface used for fixing the prosthesis 3 with the anchorage 1 to be increased.

To facilitate installation of the coupling device 2, it is particularly advantageous to provide a head 5 which has a monotonously decreasing outer wall from the foot area to the top area of the head 5. The outer face of head 5 has a shape complementary to the shape of the inner face of coupling device 2. The top face of the head 5 is designed to come into contact with the top face of the cavity designed to receive the head 5.

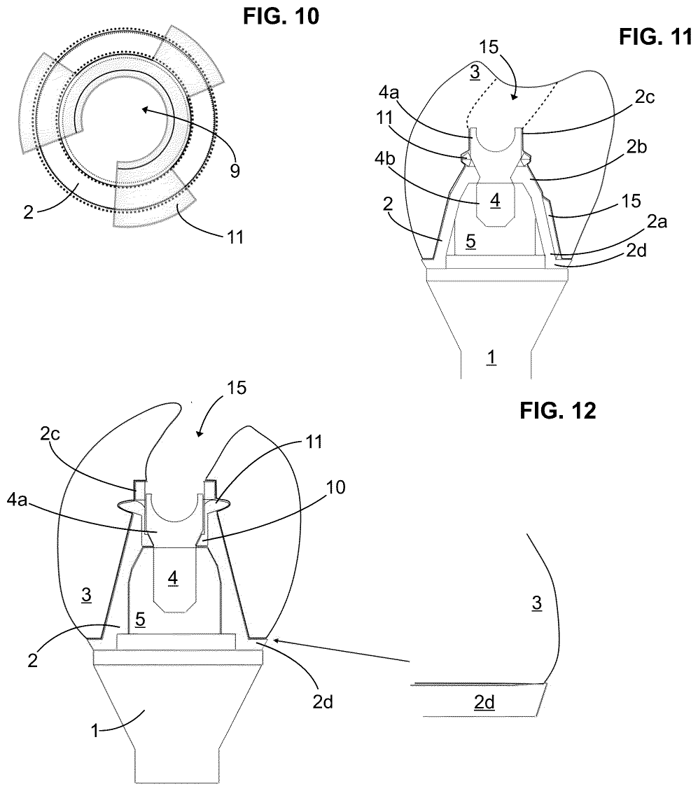

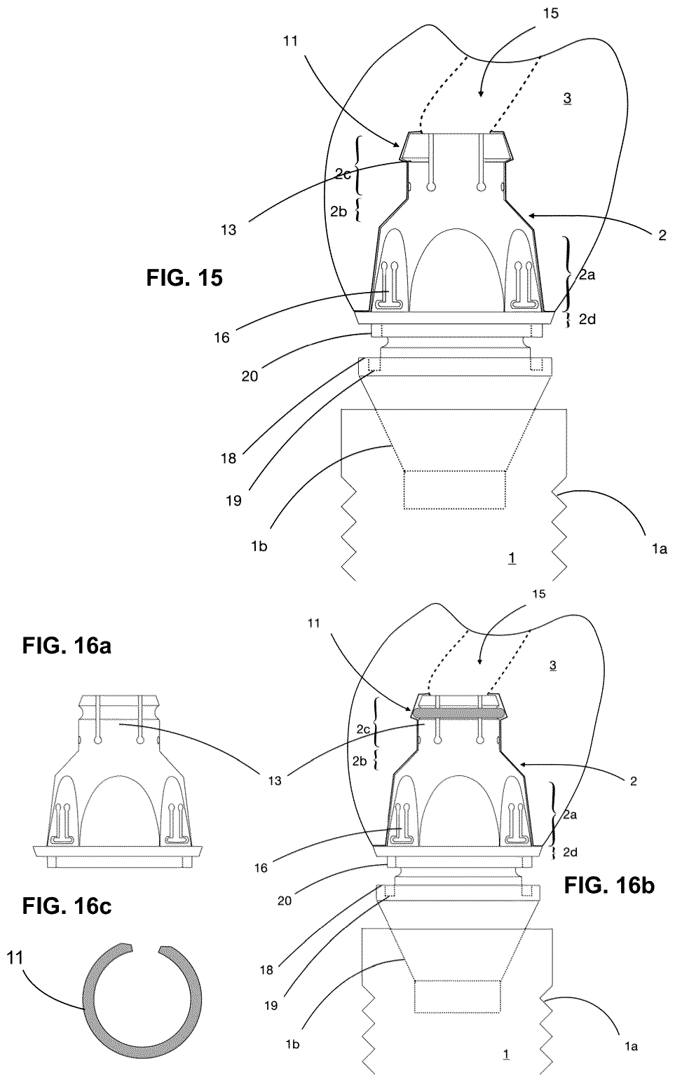

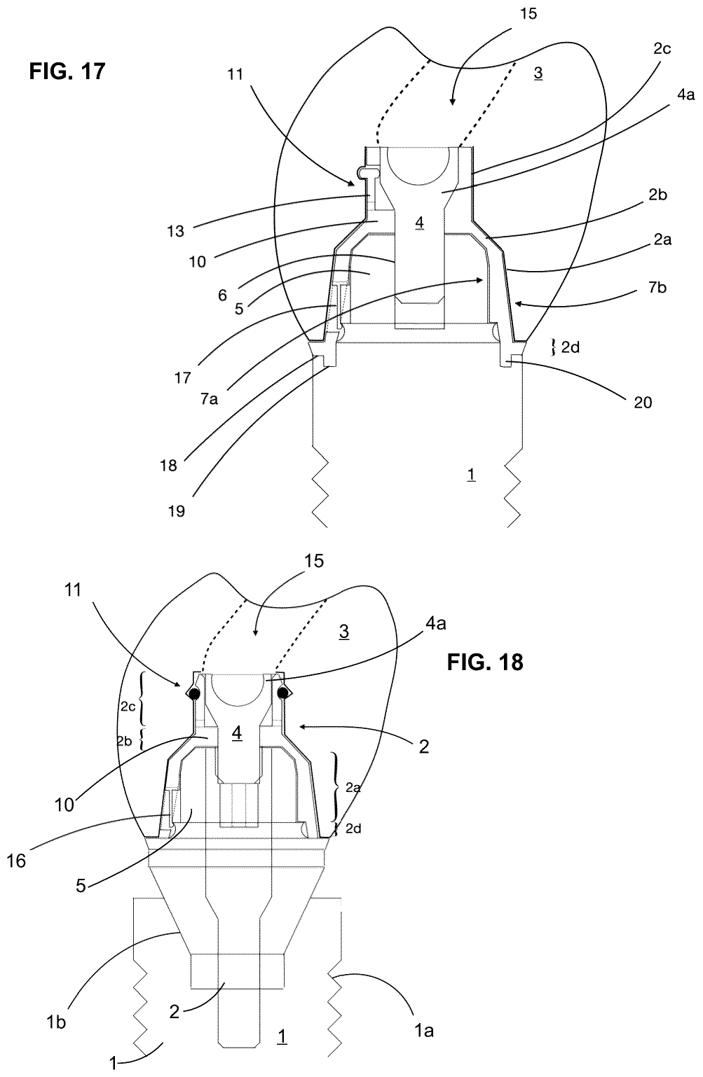

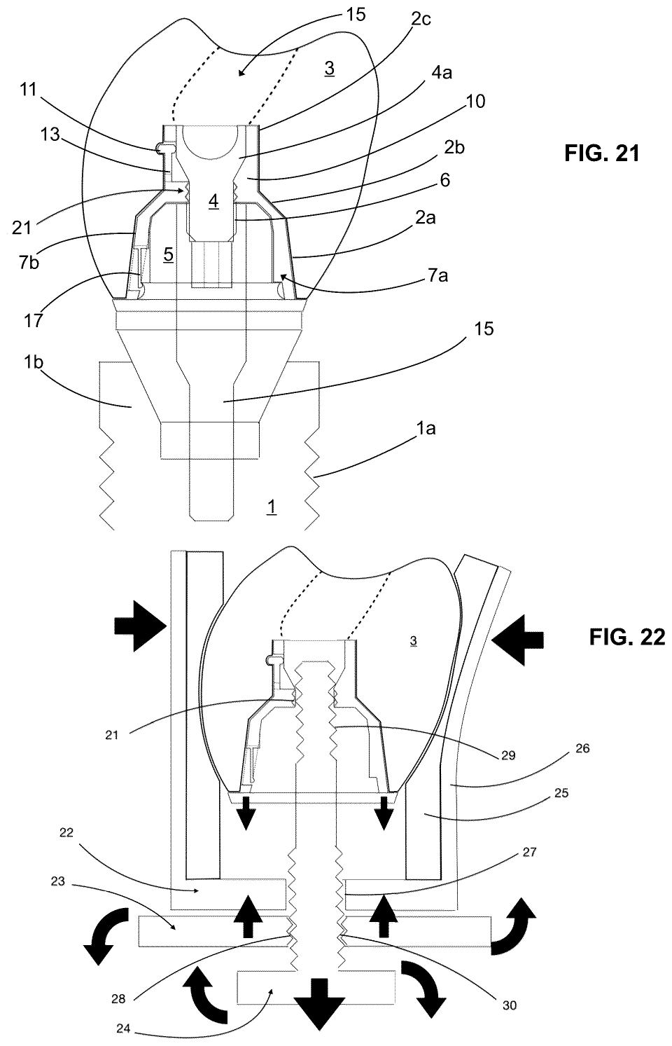

A first rotation blocker 7a configured to prevent rotation between head 5 and the coupling device 2 is preferentially present to prevent rotation of the coupling device 2 with respect to head 5 and to therefore prevent rotation of the prosthesis 3 with respect to the anchorage 1. Rotation is prevented around an axis parallel to the longitudinal axis of the fixing screw 4. The first rotation blocker 7a can be formed by a polygon, preferably a convex polygon formed on the outer surface of head 5 and a complementary shape formed by the emergent internal cavity of the coupling device 2. The use of two complementary shapes enables rotation to be prevented and ensures a strong contact enhancing absorption of the mechanical forces. Other configurations are also possible. In the configurations illustrated in FIGS. 1 to 6, 8, 9 and 12 to 22, the anti-rotation device is formed by a regular convex polygon, for example a hexagon. Other shapes of polygons are possible as are non-regular convex polygons or even non-convex polygons. It is also possible to provide any shape that prevents rotation. To prevent rotation, it is possible to form grooves 8 and/or tabs in the coupling device 2 that are inserted in or receive corresponding tabs and/or grooves of the dental prosthesis 3 as illustrated in FIG. 11.

The body of the coupling device 2 defines a through hole 9 designed to receive the fixing screw. The through hole 9 of the coupling device 2 is located in the continuation of the tapped portion 6 of the anchorage 1.

The coupling device 2 is provided with a stop 10. The stop 10 blocks a head 4a of the fixing screw so as to block the coupling device 2 against the anchorage 1 and prevent any translational movement in the longitudinal direction of the fixing screw. Rotation blocker 7a prevents rotation of the coupling device 2 around the longitudinal axis of the fixing screw with respect to the anchorage 1. When the fixing screw 4 presses on the stop 10, the coupling device 2 is installed unmovably with respect to the anchorage 1. FIGS. 4, 5 and 8, 14a, 17, 18, 20 to 22 illustrate a stop 10 formed by the body whereas FIGS. 6, 9, 11 and 12 illustrate a stop that is removable from the body.

The dental prosthesis 3 is fixed to the anchorage 1 by means of a blocker 11 connected to the body of the coupling device 2. The locking device 11 is configured to secure the prosthesis 3 to the coupling device 2. In one embodiment, the stop 10 is in direct contact with the screw head 4a. In an alternative embodiment, the screw head 4a is pressing on the blocker 11 which is itself pressing on the stop 10 (FIG. 9).

The coupling device 2 has at least one blocker 11 that is configured to present a first position called retracted position and a second position called extended position. In the extended position, the outer cross-section of the blocker 11 is larger than in the retracted position. The blocker 11 can be manufactured in different ways. The blocker 11 can be engineered to be removable or indissociable from the body of coupling element 2.

Preferentially, the blocker 11 has a resting position corresponding the extended position. When installation of the prosthesis 3 takes place, the blocker 11 deforms elastically between the extended position and the retracted position until the blocker 11 penetrates one or a plurality of recesses 12 of the prosthesis 3 to extend again. Once the prosthesis 3 installed around the coupling device 2, the blocker 11 is preferentially in the resting position. The resting position of the blocker 11 is the position of the blocker 11 when the blocker 11 is not biased by the fixing screw 4.

The blocker 11 is designed to be inserted in at least one recess 12 of the prosthesis 3 covering the coupling device 2 to fix the prosthesis 3 onto the coupling element 2. The recess 12 of the prosthesis 3 can be an annular groove. The annular groove prevents formation of an anti-rotation device between the prosthesis 3 and the blocker 11. As an alternative, several separate recesses are possible.

Movement from the first position to the second position corresponds to a transverse expansion in the direction of the dental prosthesis 3 so as to come into contact with the dental prosthesis 3. In the extended position, the blocker 11 performs mechanical fixing of the dental prosthesis 3 on the coupling element 2 by being inserted in the recess 12. The dental prosthesis 3 becomes indissociable from the coupling device 2. The blocker 11 and the recess 12 collaborate to fix the dental prosthesis 3 on the coupling device 2 and therefore on the anchorage 1. In the extended position, the blocker 11 fixes the prosthesis 3 on the coupling device 2 and prevents translation along the longitudinal axis of the fixing screw 4.

It is advantageous to form the at least one recess 12 in the top part of the dental prosthesis 3, i.e. in an area having a large quantity of material in order to reduce the risks of breaking of the dental prosthesis 3. In the illustrated exemplary embodiments, the blocker 11 is located in the head area 2c of the body for the recess 12 to be in the top portion of the prosthesis 3, i.e. the area away from the end of the foot of the coupling device 2 in order not to weaken the dental prosthesis 3 too much.

Preferentially, the blocker 11 partially obstructs the through hole 9 of the coupling device 2. The blocker 11 is preferentially deformed by means of the screw head 4a which is inserted in the through hole 9 of the coupling device 2. The screw head 4a is wider than the threaded portion 4b. When the screw head 4a is inserted in the coupling device 2, the screw head 4a moves until it presses on the blocker 11. The screw head 4a applies a force on the blocker 11 which extends toward outside and applies an effort or a greater effort on the prosthesis 3.

In a particular embodiment, the screw head 4a stresses the blocker 11 moving from the retracted position to the extended position by deformation. When the screw head 4a is up against a stop 10 of the coupling device 2, the blocker 11 is in the extended position and remains in the extended position.

By using a blocker 11 the resting position of which enables the prosthesis 3 and the coupling device 2 to be fixed together, it is then possible to simultaneously install or remove the assembly formed by the prosthesis 3 and the coupling device 2, thereby reducing handling and hence the risk of falling or ingestion. This also avoids the need for a layer of adhesive between the coupling device 2 and the prosthesis 3. An equivalent result can be achieved when the first installation of the fixing screw 4 results in the plastic deformation of the blocker 11, which has the effect of fixing the prosthesis 3 and the coupling device 2 together even after the fixing screw 4 has been removed.

Particularly advantageously, the screw head 4a has a circular cross-section of constant diameter over at least part of its height, designed to face the blocker 11 perpendicularly to the longitudinal axis of the fixing screw. The circular cross-section ensures that a constant force is applied to the blocker 11, and therefore to the prosthesis, irrespective of how far the fixing screw 4 is driven into the coupling device and the anchorage 1. This makes it possible to dissociate the force applied between the coupling device 2 and the anchorage 1 and the force applied between the blocker 11 and the prosthesis 3.

When the fixing screw 4 is against the stop 10, i.e. when the fixing screw 4 is fixed on the head 5, the screw head 4a forms an obstacle which prevents the blocker 11 from deforming towards the retracted position, i.e. towards the position which allows disengagement between the prosthesis 3 and the coupling device 2. The screw head 4a will key the blocker 11.

In an embodiment illustrated in FIGS. 1 to 5, 14a, 17, 21, 22, the blocker 11 can be formed by one or more fins 13 that are cut out from the side wall of the body of the coupling device 2. The fin or fins 13 are formed by cutting of the side wall.

In preferential manner, several fins 13 are arranged on the side wall of the body of the coupling device 2. Advantageously, the fins 13 are uniformly distributed over the circumference of the body of the coupling device 2. Depending on the configurations, the fins 13 are fitted to deform the top end or the bottom end of fin 13 when a force is applied on the screw head 4a to move the latter to the extended position. The fins 13 can move around an axis of rotation which is perpendicular to the longitudinal axis of the fixing screw. It is also possible to provide for the fins 13 to move around an axis which is parallel to the longitudinal axis of the fixing screw 4.

The fins 13 can be of any shape. It is advantageous for the movable part of the fins 13 to be provided with a salient portion which is inserted in the at least one recess, for example a groove 12 of the dental prosthesis 3 so as to reduce the size of the groove/recess along the longitudinal axis of the fixing screw 4. The salient portion can be of any shape, for example flat, rounded or pointed. In preferential manner, the fins 13 are formed in the top half of the coupling device 2. It is advantageous to form the fins 13 in the upper circular portion of the body of the coupling device 2, i.e. the head area 2c.

In an alternative embodiment illustrated in FIGS. 6 to 12, 16b, 18, 19 and 20, the blocker 11 is a part that is removable with respect to the body of the coupling device 2. The blocker 11 can be in the form of a ring or a C-shaped part. The blocker 11 passes through one or more apertures 14 of the body of the coupling device 2. The blocker 11 can be a C-shaped element 11 that partially encircles the body. The blocker 11 has a rest position in which it partially obstructs the through hole 9 of the coupling device 2. Insertion of the fixing screw in the coupling device 2 presses on the blocker 11 which moves in the at least one recess 12, for example the groove or the holes to extend beyond the outer side wall. The movement is transverse or radial.

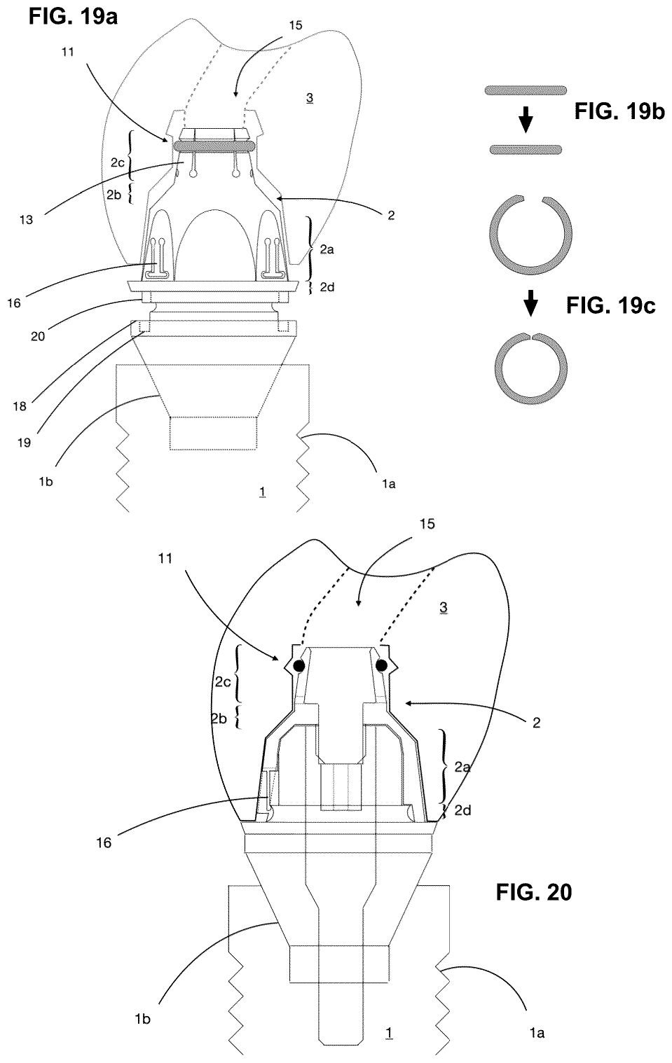

In a further embodiment illustrated in FIGS. 16a, 16b, 18 and 19a and 20, the blocker 11 has a retention element, preferably a removable part in the form of a ring and preferably in the form of a “C”, as shown in FIGS. 16c, 19b and 19c.

The head area 2c of the coupling device 2 has an annular groove designed to receive the removable part of the blocker 11. The annular groove extends around the circumference of the coupling device and overlaps the fins 13. Outward deformation of the fins 13 deforms the removable part, preventing disassembly of the prosthesis 3. It is advantageous that the blocker 11 works in the elastic deformation zone and, in the absence of the fixing screw 4, the blocker 11 forces the fins 13 into the retracted position to facilitate insertion of the prosthesis 3. When the screw head 4a presses on the stop 10, it applies a force to the fins 13, deforming the blocker 11 and applying a force to the groove 12 of the prosthesis 3, preventing the prosthesis 3 from disengaging from the coupling device 2, even during chewing efforts. In a preferred embodiment, the blocker 11 is made of a shape-memory alloy, for example NiTi. Shape-memory alloys are difficult to machine and weld. It is advantageous to form a blocker 11 with a simple shape to facilitate implementation while enjoying the same advantages as a coupling device 2 made entirely of a shape memory alloy or whose fins 13 are made of shape memory alloys. It is advantageous to use a shape-memory alloy blocker 11 which secures the prosthesis 3 to the coupling device 2 in the absence of external stress, for example after it has been plastically deformed by the first insertion of the fixing screw 4 into the coupling device 2. When the coupling device 2, the blocker 11 and the prosthesis 3 are heated above the transformation temperature of the shape memory material, the blocker 11 returns to its configuration which disengages the prosthesis 3 from the coupling device 2.

FIGS. 19b and 19c illustrate the deformation of the C-shaped blocker between the extended and retracted positions in side and top views. FIG. 19a illustrates the C-shaped blocker in the retracted position, with the prosthesis 3 pressing on the blocker 11.

FIGS. 6 and 7 illustrate an embodiment in which the screw head 4a presses on the blocker 11 and presses the latter against the stop 10 when it partially extends from the blocker 11 in the direction of the dental prosthesis 3.

FIG. 8 illustrates an embodiment where the blocker 11 is made up from two parts. A first part partially obstructs the through hole 9 and forms arms that press on a second part that passes through the at least one recess 12, for example the groove 12 or the holes of the body. When the screw head 4a presses the first part against the stop 10, the arms press on the second part which is then inserted in the prosthesis 3 to make the dental prosthesis 3 indissociable from the coupling device 2.

FIGS. 9 and 10 illustrate an embodiment where the blocker 11 is a ring placed on the stop 10 of the coupling device 2. The screw head 4a presses on the blocker 11 in the direction of the stop 10 and the blocker 11 is deformed in the direction of the at least on recess 12, for example the groove 12 of the dental prosthesis 3 to make the latter indissociable from the coupling device 2.

The blocker 11 is designed to be inserted in the at least one recess 12 such as a groove 12 in the inner cavity of the dental prosthesis 3. The blocker 11 applies a transverse or radial force on the dental prosthesis 3 securing the dental prosthesis 3 firmly on the coupling device 2. The blocker 11 is fitted reversible so that the blocker 11 enables the dental prosthesis 3 and the coupling device 2 to be fitted fixedly and allows the reverse movement from the extended position to the retracted position to enable the dental prosthesis 3 and the coupling device 2 to be separated from one another.

In this way, by removing the fixing screw 4, the mechanical fixing introduced by the blocker 11 is eliminated and it is possible to remove the prosthesis 3 without touching the anchorage 1 and in particular without applying a rotational force on the anchorage 1.

The use of the coupling device 2 as intermediate part to fix a prosthesis 3 on an anchorage 1 is particularly advantageous. As indicated in the foregoing, to facilitate its installation, the anchorage 1 has a head 5 of small dimension which tends to generate strong forces on the prosthesis 3 and therefore incites the use of hollow anchorages for performing fixing of the prosthesis by means of an abutment screw which is a long and broad. When a specific abutment receiving the prosthesis 3 by adhesion is used, this gives rise to the above-mentioned problems as regards the adhesive.

The use of a coupling device 2 enables a larger contact surface with the prosthesis 3 to be provided which reduces the forces at the interface with the prosthesis 3. This makes it possible in particular to reduce wear of the inner wall or risks of breaking of the prosthesis 3 when the latter is made of ceramic.

It is particularly advantageous to provide for the coupling device 2 to present an outer cross-section that has a monotonic decrease from the foot area 2a to the head area 2c. The foot area 2a comes into contact with the anchorage 1. The head area 2c corresponds to the opposite end and is located close to the top of the prosthesis 3. The monotonic decrease is observed without taking account of the blocker 11. Such a configuration associated with a complementary shape in the inner cavity of the prosthesis 3 enables a prosthesis 3 to be formed with a thickness of material in the dental prosthesis that is greater in its top than in its foot. It is then easier for the prosthesis 3 to withstand chewing stresses, preferably at least twice as much. By reducing the external cross-section of the coupling device 2, the cross-section of the through-hole in the upper part of the prosthesis 3 is reduced, thereby increasing its mechanical strength.

The dental prosthesis 3 can be made from different materials, for example a ceramic, a polymer material or a metal alloy. The dental prosthesis 3 can reproduce the shape of a tooth or a plurality of teeth. The dental prosthesis 3 can be covered by a cosmetic material or comprise a cosmetic material. The dental prosthesis 3 defines a through hole 15 extending in a longitudinal direction. The through hole 15 extends from the coronal end to the apical end of the dental prosthesis 3. The coronal end is designed to come into contact with an opposite tooth whereas the apical end is designed to come into contact with the coupling device 2 and/or possibly with the implant 1a. As the dental prosthesis 3 is tailor-made to replace one or more teeth, its dimensions are less well mastered than those of the coupling device 2 and of the head 5. It is therefore particularly advantageous to use a coupling device 2 made from metal to perform fixing on the anchorage 1 and to offset fixing of the dental prosthesis 3. Such a configuration reduces the risks of infection that occur when the dental prosthesis 3 does not fit perfectly on the head of the anchorage 1.

The outer shape of the coupling device 2 and the shape of the cavity of the prosthesis 3 are as complementary as possible in order to achieve a good transfer of the forces between the prosthesis 3 and the anchorage 1. The cavity presses on the coupling device 2. In a particular embodiment, prosthesis 3 is devoid of any contact with the anchorage 1. In advantageous manner, the top surface of the coupling device 2 is covered by the dental prosthesis 3 so that the dental prosthesis 3 presses on this portion of the coupling device 2 and absorbs a part of the forces in the longitudinal direction of the fixing screw.

Once the prosthesis 3 has been fitted on the coupling device 2, the through hole 15 comes into the extension of the through hole 9. The dental prosthesis 3 is installed on the coupling device 2 via the apical part, i.e. from the top, which makes installation of the dental prosthesis 3 easier.

The fixing screw 4 is inserted via the top of the prosthesis 3. The fixing screw 4 passes through the through hole 15 to reach the through hole 9 and the stop 10. In preferential manner, the through hole 15 of the prosthesis 3 has a cross-section that allows the fixing screw 4 to pass right through. The fixing screw 4 can pass freely through the through hole 15. The through hole 15 has a minimum cross-section that is larger than the maximum cross-section of the fixing screw 4. In other words, the through hole 15 allows the fixing screw 4 to pass right through the dental prosthesis 3. The apical end of the through hole 15 is tapered so as to define a cavity that receives the coupling device 2. The cavity designed to receive the coupling device 2 has a decreasing cross-section from its bottom end to its top end.

The coupling device 2 provides the mechanical connection between the head 5 and the prosthesis 3. The coupling device extends beyond the head 5 in the longitudinal direction so as to have a larger contact surface between the prosthesis 3 than the contact surface between the head 5 and the coupling device 2. The coupling device 2 defines an internal cavity designed to receive the head 5 of the anchorage, the cavity extending from the pedestal area of the coupling device, i.e. the area designed to come into contact with the anchorage all around the head 5, to the through hole designed to receive the fixing screw 4. The cavity has a decreasing cross-section from the pedestal area to the top face defining the through hole for the fixing screw 4. Preferably, the cross-section is continuously decreasing. The cavity is located between the stop 10 and the pedestal area, making it easier to achieve a compact configuration and better force absorption. The prosthesis 3 rests on the outer face of the coupling device 2 and the inner face of the coupling device 2 rests on the head 5. The prosthesis 3 and the head 5 face each other on the outside face and inside face of the coupling device 2 in a cross-sectional plane perpendicular to the longitudinal axis of the through hole, which is the longitudinal axis of the fixing screw 4. Face-to-face mounting ensures better force transfer between the prosthesis 3 and the head 5. When the fixing screw 4 is installed, the fixing screw 4, the head 5, the coupling device 2 and the prosthesis 3 belong to the same plane perpendicular to the longitudinal axis of the fixing screw 4.

The through hole 15 of the prosthesis 3 can be curved or have an axis offset from that of the through hole 9 of the coupling device 2.

The coupling device 2 only covers a part of the inner wall defining the through hole 15. The overlap is observed in a direction perpendicular to the longitudinal axis of the fixing screw 4. The coronal end of the through hole 15 is not covered by the coupling device 2.

The tapped portion 6 is arranged beyond the terminal plane of the gingiva, i.e. beyond the upper terminal plane for the bottom jaw bone and the lower terminal plane for the upper jaw bone.

The coupling device 2 has a simple shape which enables it to be manufactured with a great dimensional precision, for example by machining. As the manufacturing precision is high, the dimensions are well mastered enabling a precise mechanical connection to be formed with the anchorage 1 for a good transmission of the forces. In advantageous manner, the coupling device 2 is formed exclusively by one or more circular sections and/or one or more frusto-conical sections. It is advantageous to have a frusto-conical portion of the head 5 and a complementary frusto-conical portion on the inner surface of the body to have a good transmission of the forces in the longitudinal direction of the through hole 9.

In the embodiment illustrated in FIGS. 1 to 6, 8, 9,11, 13 to 22, the coupling device 2 is broken down into a plurality of distinct portions fitted successively in the longitudinal direction of the coupling device 2. In the embodiment illustrated in FIGS. 1 to 5, the coupling device 2 successively comprises three areas or at least three areas from the bottom end up to the top end. There is a foot area 2a of frusto-conical shape followed by a constricted area 2b also of frusto-conical shape and a head area 2c of circular shape. The two frusto-conical areas become narrower from their bottom portion up to their top portion. The cross-section constriction introduced by constricted area 2b is greater than that introduced by the foot area 2a. The constricted area 2b provides a support for the dental prosthesis 3 for a good transmission of the mechanical forces between the dental prosthesis 3 and the coupling device 2. The head area 2c is circular and its top is covered by the prosthesis 3 for a better stress take-up.

In an alternative embodiment illustrated in FIGS. 6, 8 and 9, the coupling device 2 has a foot area 2a of frusto-conical shape followed by a circular head area 2c. The dental prosthesis 3 defines at least one recess having the shape of a groove 12 designed to receive the blocker 11 in the form of a ring or having a C-shape such as the one illustrated in FIG. 7 or in FIG. 10. In one particular case, a slot receiving the blocker 11 separates the foot area 2a and the head area 2c. In another particular case, the slot is located in the foot area 2a and the foot area 2a extends after the slot up to the head area 2c.

In an alternative embodiment that is not illustrated, the coupling device 2 has a foot area 2a of frusto-conical shape followed by a head area 2c of frusto-conical shape. The head area 2c has a more marked incline than that of the foot area 2a. The incline is the angle that exists between the outer side wall and the longitudinal axis of the centre of the hole designed to receive the fixing screw 4.

FIG. 11 illustrates a coupling device 2 with three consecutive areas such as in FIGS. 1 to 4 and a slot receiving the blocker 11 is located between constricted area 2b and the head area 2c.

In preferential manner, the screw head 4a is of circular and not frusto-conical cross-section in its portion designed to come into contact with the blocker 11. The circular cross-section extends into the body of the coupling device 2. With a circular cross-section, deformation of the blocker 11 is constant independently from the depth of depression of the screw head 4a. The diameter of the screw head 4a defines the deformation and therefore the holding force applied by the blocker 11 on the prosthesis 3. The intensity of pressing of the screw head 4a on the stop 10 defines the holding force of the coupling device 2 on the anchorage 1 and therefore partially defines the holding force of the prosthesis 3 on the anchorage 1. This configuration enables the securing forces applied on the prosthesis 3 to be better mastered thereby reducing the risks of breaking of the prosthesis, notably that of ceramic prostheses 3. This configuration limits the mechanical stress on the dental prosthesis 3 in the longitudinal direction departing from the fixing screw 4. The illustrated configuration is more advantageous than that presented in the document KR 10-1943437 or US2020/0015940.

Increasing the contact surface with the prosthesis 3 by means of the coupling device 2 reduces the stresses applied on the prosthesis to prevent displacement of the latter with respect to the anchorage 1. As the stresses are reduced, it is possible to use a fixing screw that is narrower and/or shorter. By using a narrower fixing screw, the cross-section of the through hole 15 passing through the prosthesis 3 is able to be reduced. There is then more material available at least in the top part of the prosthesis 3 resulting in an enhanced strength and improved aesthetics.

The use of a shorter screw 4 makes it easier to make a curved through hole 15. It is easier to define the position of the top end of the through hole 15 to facilitate insertion of the fixing screw and/or to make the through hole 15 less visible.

The use of a shorter screw 4 also enables the depth of the tapped portion 6 in the anchorage 1 to be reduced. This is particularly advantageous when the anchorage 1 has an abutment 1b as it enables the height of the abutment to be reduced. The tapped portion 6 can extend up to less than half the height of the implant, preferentially only in the top third of the implant and even more preferentially only in the portion located above the jaw bone. It is advantageous for the tapped portion to only be situated in the head 5 and/or not to extend beyond the coupling device 2.

The use of a shorter and/or narrower the fixing screw makes it easier to use a tapped section 6 that is offset with respect to the insertion axis of the implant 1a. It is advantageous to use trans-screwed angled abutments for screw-fastened prostheses. To facilitate installation and fixing of the prosthesis 3, it is known to fix the prosthesis by means of a screw that is inclined with respect to the axis of depression of an implant by means of angled abutments. The use of a coupling device 2 that improves the contact with the prosthesis 3 enables the dimensional constraints on the fixing screw to be reduced thereby enabling the accessible angulation range to be increased. It is possible to form a tapped portion 6 the longitudinal axis of which is inclined at least 15° with respect to the longitudinal axis of the implant, and preferably at least 20° or even at least 30°.

In preferential manner, the dental prosthesis 3 defines at least one recess 12 having a shape of an annular groove so as to receive the blocker 11 in the extended position without forming an anti-rotation device. As an alternative, the dental prosthesis 3 defines a plurality of recesses designed to receive salient areas of the blocker 11, for example the fins 13.

It is advantageous to dissociate the securing function of the prosthesis 3 in the longitudinal direction and the anti-rotation function between the prosthesis 3 and the coupling device 2. A second rotation blocker 7b is used between the body and the prosthesis 3. As the coupling device 2 enables the contact surface with the prosthesis 3 to be increased, the dimensional constraints on the second rotation blocker 7b are reduced. The second rotation blocker 7b configured to prevent rotation of the prosthesis 3 with respect to the coupling device 2, also called second anti-rotation device, can be formed by a polygon on the outer wall of the coupling device 2 and a complementary shape in the cavity of the dental prosthesis 3. Rotation is prevented around an axis parallel to the longitudinal axis of the fixing screw 4. Other configurations are also possible. Installing the rotation blocker 7b in the lower part of the coupling device 2 places the rotation blocker 7b in the foot area of the prosthesis 3, making it more effective as the available cross-section is increased.

It is particularly advantageous to have an anti-rotation device 7b formed on the outer wall of the coupling device 2, as this provides a large usable surface area, which facilitates the transfer of forces between the prosthesis 3 and the coupling device 2, as the dimensions of the prosthesis 3 are less well controlled than for the head 5. It is particularly advantageous to have an anti-rotation device 7b arranged between the stop 10 and the pedestal area of the coupling device 2, as the available body cross-section is large, making it easier to transfer forces between the prosthesis 3 and the coupling device 2 to prevent rotation of the prosthesis 3. Preferably, the anti-rotation device 7b extends over less than 50% of the cavity height. Advantageously, the anti-rotation device 7b extends from the foot of the body. It is particularly interesting to provide that the anti-rotation device 7b is formed by a regular polygon on the outer face of the body.

In particularly advantageous manner, the first anti-rotation device 7a and the second anti-rotation device 7b belong to one and the same plane perpendicular to the longitudinal axis of the fixing screw 4. The first anti-rotation device surrounds the second anti-rotation device which is favourable. The first anti-rotation device can have a shape that is identical to or different from that of the second anti-rotation device. It is advantageous to have two rotation blockers with identical shapes. FIGS. 1 to 5 illustrate first and second rotation blockers 7a and 7b in the form of regular convex polygons whereas FIG. 11 illustrates formation of a tab 15 and a groove extending in the longitudinal direction.

In the case where the dental prosthesis 3 forms several teeth, it is preferable not to use rotation blocker 7a between the coupling device 2 and multiple anchorages 1 to facilitate insertion of the plural dental prosthesis (bridge). The prosthesis 3 is fixed to the jaw bone by means of several anchorages 1 that are capped by a coupling device 2 and a fixing screw 4.

In a preferential embodiment, the outer surface of the coupling device 2 in contact with the inner surface of the cavity arranged in the prosthesis 3 is covered by a covering layer made from polymer material. The covering layer, also called coating, forms a seal providing the tightness between the coupling device 2 and the prosthesis 3. As an alternative or as a complement, the covering layer is formed on the outer wall of the head 5 to form a seal between the head 5 and the prosthesis 3.

In preferential manner, the polymer layer has a thickness comprised between 15 μm and 150 μm, preferably between 75 μm and 100 μm, more preferentially between 50 μm and 100 μm. In preferential manner, the covering layer is constituted by or comprises PolyTetraFluoroEthylene (PTFE), PolyEtherEtherKetone (PEEK), PolyEtherKetoneKetone (PEKK) or their derivatives, for example their fluorinated derivatives. These materials are particularly advantageous as they are compatible with titanium, titanium alloys and also with shape memory materials, such as Nitinol for example. Other materials having a biocompatibility can be used for this coating. It is also possible to use hydrophobic polycationic polymers, for example those divulged in the document U.S. Pat. No. 10,500,317. The use of a hydrophobic coating layer inhibits formation of a biofilm on the anchorage 1 and in particular the head 5 and/or the coupling device 2.

The coating layer can cover the vertical portion of the coupling device 2 and/or the salient portion of the anchorage 1 to enhance the strength.

In a particular embodiment, the coating layer is coloured so as to present a white colour close to that of the tooth or a pink colour close to that of the gingiva. The colouring of the coating layer masks the colour of the metal material forming the coupling device 2 and/or the anchorage 1 through the dental prosthesis 3 by transparency.

It is particularly advantageous to provide for the outer surface of the coupling device 2 to be covered by a coating layer and preferably by a coating layer having a thickness comprised between 30 μm and 75 μm. The thickness of the coating layer can be uniform, but it is advantageous to provide a larger thickness on the fins 13 and the expansive elements 11.

In preferential manner, the coupling device 2 is provided with a peripheral rim 2d that forms the bottom end of the coupling device and that is designed to support the peripheral bottom end of the dental prosthesis 3. The peripheral rim 2d can also be covered by a coating layer having a larger thickness than the mean thickness of the coating layer, for example at least 10% larger. The peripheral rim 2d is preferentially supported by the anchorage 1. Preferably, the peripheral rim 2d is covered only or covered at least on its upper part by the covering layer.

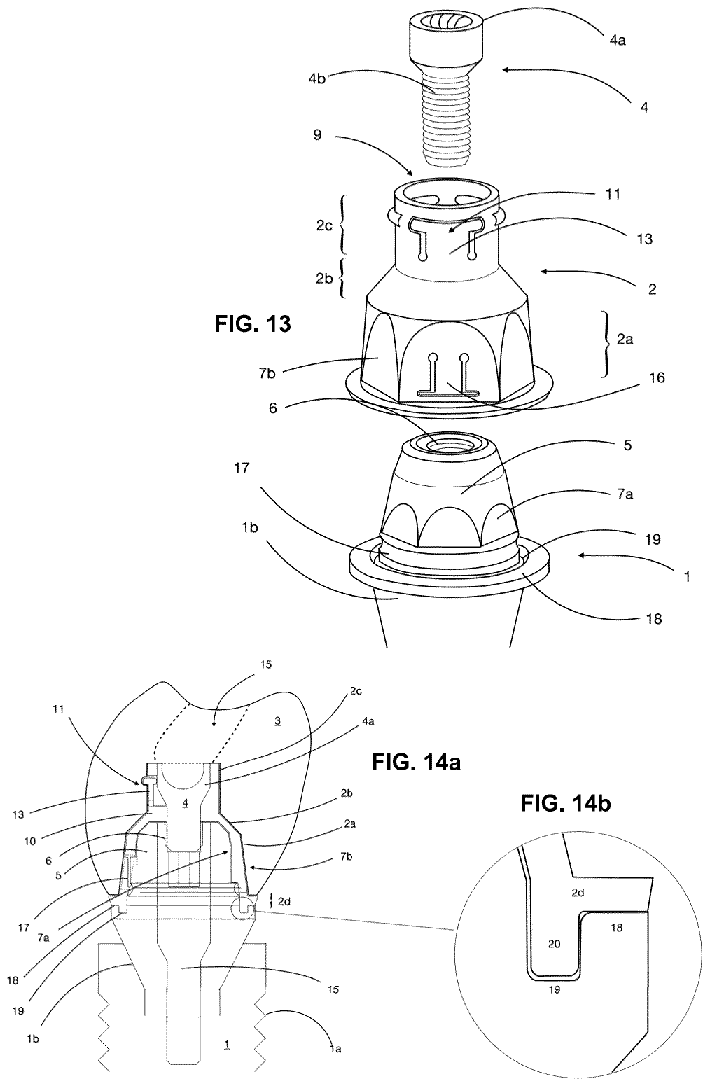

Preferably, in an embodiment illustrated in FIGS. 13, 14a and 14b, the anchorage 1 has an implant abutment with a peripheral shoulder 18 which is designed to receive the peripheral rim of the coupling device 2 so that the coupling device 2 is supported on the anchorage 1. The grip is designed to take up forces in the longitudinal direction of the fixing screw 4.

Advantageously, the peripheral shoulder 18 defines an annular groove 19. The foot region of the coupling device 2 has a projecting portion 20 which fits into the annular groove 19. Preferably, the peripheral shoulder 18 extends outwards from the annular groove 19 to enable the coupling device to be supported around the annular groove. By inserting the projecting portion 20 into the annular groove 19, the coupling device 2 is better held in position relative to the anchorage 1. This allows better absorption of forces, particularly lateral stresses. This reduces the transmission of lateral forces to the fixing screw 4, thereby reducing the risk of unscrewing. The protruding portion can be a single protruding portion, for example circular, or formed by a plurality of protruding zones. The peripheral shoulder 18 and the coupling device 2 form an annular joint.

The peripheral rim 2d extends continuously around the coupling device 2 and the dental prosthesis 3 makes a continuous peripheral contact with the peripheral rim 2d. The contact between the dental prosthesis 3 and the rim 2d forms a ring. In order to improve the tightness between the coupling device 2 and the dental prosthesis 3, the top surface of the peripheral rim 2d is inclined upwards from the centre towards the periphery of the coupling device 2, the top corresponding to the upper plane formed by the top of the coupling device 2, as opposed to the bottom formed by the contact area with the abutment 1b or the implant 1a. The terminal end of the dental prosthesis 3 designed to come into contact with the peripheral rim 2d is flat. A greater force is present in the outer portion of the peripheral rim 2d to better compress the coating layer if required.

The tilt angle is small, advantageously less than 10°, preferentially less than 5° and even more preferentially comprised between 0.5° and 2.5°. In the illustrated embodiments, the reference plane is formed by the central part of the top surface of the peripheral rim 2d. When moving towards the periphery, the top surface is inclined in the upwards direction by the tilt angle. In the illustrated exemplary embodiment, the interface plane with the anchorage is parallel to the plane defined by the central portion of the top surface of the peripheral rim 2d.

In an alternative embodiment, the top surface of the peripheral rim 2d is flat and the bottom surface of the dental prosthesis 3 is inclined. The outer portion is lower than the inner portion to obtain an equivalent result to that described in the foregoing. However, this embodiment is more difficult to achieve with a ceramic the dental prosthesis 3. According to another approach, the coating layer presents a progressive increase of the thickness of the coating from the centre to the outside so as to form a more efficient seal between the prosthesis 3 and peripheral rim 2d.

In preferential manner, the transverse cross-section of the peripheral rim 2d is larger than the transverse cross-section of the dental prosthesis 3.

Advantageously, the cross-section of the dental prosthesis 3 is smaller than the cross-section of the peripheral rim 2d by a value comprised between 100 μm and 200 μm. In this way, the peripheral rim 2d protrudes outwards all around the contact area between the peripheral rim 2d and the dental prosthesis 3 thereby providing a good tightness. Such an embodiment is illustrated in FIGS. 4, 6, 8, 9, 11, 14a, 15, 16b, 17, 18, 19a, 20, 21 and 22.

FIG. 12 illustrates an embodiment with the peripheral rim 2d extending beyond the prosthesis 3. FIG. 12 also illustrates an embodiment in which the outer portion of the peripheral rim 2d is raised in the direction of the prosthesis 3 from the central part to the peripheral part. The left-hand part of the figure illustrates an implant dental restoration with an anchorage 1 capped by a head 5. The head 5 is covered by the coupling device 2. The blocker 11 is in a single piece with the stop 10 that presses on the head 5. The fixing screw is screwed into the tapped portion 6. The screw head 4a presses on the stop 10. The screw head 4a deforms the blocker 11 which passes through the through-hole or the through-holes of the body blocking the blocker 11 and the coupling device 2 against the head 5.

In an advantageous embodiment, the coating layer comprises metal particles or metal ions, for example particles of silver or silver ions. An embodiment has already been illustrated in the document U.S. Pat. No. 5,984,905. The use of metal ions avoids duplication of the bacterial DNA.

In a particular embodiment, the blocker 11 is deformed elastically between the retracted position and the extended position. Installation of the fixing screw 4 elastically moves the blocker from the retracted position to the extended position. Removal of the fixing screw 4 elastically moves the blocker from the extended position to the retracted position enabling the prosthesis 3 and the coupling device 2 to be separated from one another.

In another particular embodiment, the blocker 11 is deformed plastically between the retracted position and the extended position. Installation of the fixing screw 4 moves the blocker from the retracted position to the extended position blocking the dental prosthesis 3 against the coupling device 2. Removal of the fixing screw does not result in movement from the extended position to the retracted position. The prosthesis 3 and the coupling device 2 remain fixed to one another which can facilitate disassembly of the dental restoration. It is then advantageous to manufacture the blocker 11 or the whole coupling device 2 from shape memory material. By heating the blocker 11 beyond a threshold temperature, it is possible to make the blocker 11 revert to the retracted position and therefore separate the dental prosthesis 3 and the coupling device 2 from one another. For example, the threshold temperature is higher than 100° C. to obtain the phase change and shape change. The blocker 11 reverts to the retracted position. Separation between the prosthesis 3 and the coupling device 2 is performed after separation from the anchorage 1 which is easier to manage.

The embodiments described in the foregoing are particularly advantageous for formation of a single or plural dental restoration. A trans-screwed prosthesis is able to be formed, i.e. a prosthesis secured by means of a fixing screw 4 screwed into an implant anchorage 1 thereby facilitating assembly and disassembly of the latter. The anti-rotation device or devices can be formed easily and in compact manner. Secure fixing is obtained without adhesive or sealing.

As the dimensions of the coupling device 2 are better mastered, it is easier to deposit the coating layer to improve the tightness of the restoration without generating stress concentration areas.

The prosthesis 3 defines a cavity that receives the coupling device 2 through which the fixing screw 4 passes. To be able to tighten or loosen the fixing screw 4 in difficult positions, the terminal opening of the screw head 4a is preferentially provided with a cylindrical or cylindro-conical opening to receive a screwdriver with a spherical end. It is then easier to tighten or loosen the fixing screw when the screwdriver is not in the longitudinal axis of the fixing screw. Different embodiments have been presented in the documents WO2019/168671 and EP2607722.

In preferential manner, the coupling device 2 is fixed to the dental prosthesis 3 prior to installation of the coupling device 2 on the anchorage 1. The coupling device 2 fixed to the dental prosthesis 3 can also be separated by means of an extractor if modifications of the dental prosthesis are necessary. The assembly is not provided with the fixing screw 4. Once the assembly has been placed on the abutment 1b or the implant 1a, the fixing screw passes through the through hole 15 and the through hole 9. Installation of the fixing screw 4 acts on the blocker 11 which is deformed to make the dental prosthesis 3 indissociable from the coupling device 2. It is then possible to install the assembly on the abutment 1b or the implant 1a. This assembly makes the dental surgeon's work easier as the latter can perform assembly outside the buccal cavity, i.e. in a more spacious area without any danger for the patient who could swallow these components.

In advantageous manner, the bottom end of the coupling device 2 and the anchorage 1 are provided with one or more clipping devices 16 that are configured to clip the coupling device 2 onto the anchorage 1. The clipping device or devices 16 deform elastically to allow the coupling device 2 to be fixed on the anchorage 1 and to subsequently be easily removed without having to screw the fixing screw 4. The clipping device 16 does not enable the chewing forces to be supported and does not circumvent the need for the fixing screw 4. In the illustrated embodiment, the clipping device is formed by fins formed in the bottom part of the coupling device 2. The fins are terminated by a salient area that is designed to be inserted in a groove 17 of the abutment 1b or of the implant 1a. An opposite configuration is possible. When the coupling device 2 is fixed on the abutment 1b or the implant 1a, the fins are deformed to be inserted in groove 20.

When the blocker 11 is configured to be inserted into the prosthesis 3 in the absence of stress, in order to facilitate separation between the prosthesis 3 and the coupling device 2, it is preferable to use an extractor 22 such as that illustrated in FIG. 22. This extractor 22 is particularly advantageous when the blocker 11 is not made of a shape-memory alloy that is configured to allow disengagement between the prosthesis 3 and the coupling device 2 when the blocker 11 is heated above a threshold temperature.

It is advantageous for the through-hole 9 to be threaded preferably in the stop zone 10, i.e. between the stop 10 receiving the screw head and the cavity receiving the head 5. The threaded portion 21 of the through hole 9 slides along a first threaded portion 29 of the threaded rod. The extractor 26 also has a gripping element 25 which comes into contact with the prosthesis 3 and opposes displacement of the prosthesis 3. The threaded rod passes through the gripping element 25. The threaded rod slides into the thread 21 of the stop 10 of the coupling device 2, and rotation of the threaded rod generates a force on the coupling device 2 along the longitudinal axis of the threaded rod. The gripping element 25 in contact with the prosthesis 3 opposes the movement of the prosthesis 3, which introduces a force between the prosthesis 3 and the coupling device 2 that has the effect of disconnecting the prosthesis 3 and the coupling device 2. Advantageously, the threaded rod has a second threaded portion 30 that slides into a holding plate 23. The holding plate 23 has a threaded portion 28. The holding plate 23 rests on the extractor so as to push the extractor 26 towards the assembly formed by the prosthesis 3 and the coupling device 2. The first threaded portion 29 pulls the coupling device 2 towards the holding plate 23. The fixing screw 4 does not have a thread which slides along the thread 21 of the stop zone.

In advantageous manner, the dental restoration is formed on a laboratory model.

1-16. (canceled)

17. A coupling device for securing a dental restoration prosthesis to a maxillary implant anchorage, the coupling device comprising:
a body extending in a longitudinal direction with a foot end and a head end, the body defining a through-hole extending from the foot end to the head end and designed to receive a fixing screw, the foot end being designed to bear on the maxillary implant anchorage, the body having an external cross-section decreasing from the foot end to the head end, wherein an external wall of the body is not circular to form a first part of an external anti-rotation device designed to prevent rotation between the prosthesis relative and the coupling device
wherein the external anti-rotation device extends from the foot end;
a stop designed to block a screw head of said fixing screw to fix the coupling device to the maxillary implant anchorage;
a blocker fixed to the body, the blocker is deformable and has a retracted position and an extended position, the extended position having a larger external cross-section than the cross-section of the retracted position wherein, in the extended position, the blocker is designed to be inserted into at least one recess of a prosthesis covering the coupling device to immobilize the prosthesis on the coupling element along said longitudinal direction, wherein the blocker has a resting position which is the extended position for fixedly mounting the prosthesis on the coupling device in the absence of the fixing screw;
wherein an internal face of the body defines a cavity designed to receive a head projecting from the maxillary implant anchorage, the cavity having a cross-section decreasing from the foot end to a top face, the through hole opening into the top face for the passage of the fixing screw and the foot zone forming a ring around the head, the cavity facing the first part of the external anti-rotation device perpendicularly to the longitudinal direction;
wherein the stop is arranged between the blocker and the cavity in the longitudinal direction.

18. The coupling device for a dental restoration prosthesis according to claim 17 wherein the blocker is made from shape memory alloy, the blocker being designed to be plastically deformed from the retracted position to the extended position by insertion of the screw head when the screw head presses on the stop.

19. The coupling device for a dental restoration prosthesis according to claim 17 wherein the inner wall of the body defining the cavity forms a first part of an internal anti-rotation device configured to block rotation of the coupling device relative to the head, the internal anti-rotation device extending from the foot region towards the head region, the first part of the internal anti-rotation device facing the first part of the external anti-rotation device perpendicularly to the longitudinal axis.

20. The coupling device for a dental restoration prosthesis according to claim 17 wherein the outer wall of the body is covered by a coating layer made from compressible polymer material.

21. The coupling device for a dental restoration prosthesis according to claim 17 wherein the external anti-rotation device is distinct from the blocker and wherein the external anti-rotation device extends from the foot area of the body or from a peripheral curb designed to receive the foot of the prosthesis.

22. The coupling device for a dental restoration prosthesis according to claim 17 wherein the external anti-rotation device has a larger cross-section than the cross-section of the blocker in an observation plane perpendicular to the longitudinal axis.

23. A coupling device for a dental restoration prosthesis according to claim 17 and comprising a fixing screw having a screw head with a circular cross-section to have a constant deformation of the blocker independently of the driving of the screw head into the through hole, the screw head forming an obstacle preventing the deformation of the blocker from the extended position to the retracted position when the screw head is bearing on the stop.

24. The coupling system for a dental restoration prosthesis according to claim 23 wherein the fixing screw has a length that is smaller than the length of the coupling device, the length being measured along the longitudinal axis.

25. The coupling system for a dental restoration prosthesis according to claim 23 comprising an anchorage designed to be installed in a jaw bone, the anchorage having a head of convex shape and designed to be salient from a gingiva, the head extending in a longitudinal direction and defining a tapped portion extending at least partially outside the gingiva and the jaw bone, the head having an outer cross-section that is complementary to the inner cross-section of the cavity, the head and cavity forming a rotation blocker configured to prevent rotation of the coupling device with respect to the head around an axis parallel to the longitudinal axis, the fixing screw being screwed into the tapped portion, the coupling device being fitted removable with respect to the head.

26. The coupling system for a dental restoration prosthesis according to claim 25 wherein the tapped portion does not extend beyond the height of the overlap by the coupling device on the anchorage.

27. The coupling system for a dental restoration prosthesis according to claim 25 wherein the coupling device and the anchorage define a clipping device configured to fix the coupling device to the anchorage by elastic deformation.

28. The coupling system for a dental restoration prosthesis according to claim 25 wherein the anchorage has an implant abutment defining an annular groove and wherein the foot region of the coupling device has a projecting portion fitting into the annular groove, the foot region extending radially outwardly from the projecting portion to form a base region in contact with a bearing region on the implant abutment.

29. A dental restoration comprising a coupling system according to claim 25 and comprising a prosthesis having a through hole opening onto the through hole of the coupling device, the through hole of the prosthesis broadening out from its apical end to its coronal end.

30. The dental restoration according to claim 29 wherein the fixing screw is devoid of contact with the prosthesis.

31. The dental restoration according to claim 29 wherein the prosthesis is devoid of contact with the anchorage.

32. A method for performing a dental restoration comprising the following steps:
providing an anchorage designed to be fixed on a jaw bone of a laboratory model, the anchorage having a head designed to be mounted salient with respect to the gingiva, the head defining a tapped portion extending at least partially outside the gingiva and the jaw bone;
providing a coupling device according to claim 17;
providing a prosthesis defining a through hole;
placing the coupling device and the dental prosthesis on the head, the coupling device being located between the head and the prosthesis;
passing a fixing screw through the through hole of the prosthesis and the through hole of the coupling device;
screwing the fixing screw into the tapped area until it presses up against the stop, the fixing screw fixing the coupling device on the anchorage and deforming the blocker so that the blocker is inserted in the at least one recess of the prosthesis to fixedly assemble the coupling device and the prosthesis in the longitudinal direction,
removing the fixing screw and detaching the assembly formed by the coupling device and the prosthesis from the anchorage of a laboratory model.
fitting the assembly formed by the coupling device and the prosthesis in the mouth, then securing this assembly to the anchorage using the fixing screw.
